(19) United States
(12) Patent Application Publication
(10) Pub. No.: US 2009/0279942 A1
(43) Pub. Date: Nov. 12, 2009

(54) Device for fastening an object on a flat carrier,particularly for furniture

(76) Inventors: David Pecar, Pobegi (SI); Valter Svara, Izola (SI)

Correspondence Address: JACOBSON HOLMAN PLLC, 400 SEVENTH STREET N.W., SUITE 600, WASHINGTON, DC, 20004, US

(21) Appl. No.: 11/918,740

(22) PCT Filed: Apr. 19, 2006
(86) PCT No.: PCT/SI2006/000017

§ 371 Date: Dec. 10, 2008

(30) Foreign Application Priority Data
Apr. 22, 2005 (SI) P-200500122

(51) Int. Cl. F16B 12/20

(52) U.S. Cl. 403/8

(57) ABSTRACT

It concerns a set of a nut carrier (1; 11) and two translatory or rotary guided nuts in it or a set of a nut carrier (21; 31) and of only one nut guided in it in a translatory or rotary way. The nut is always part of a translatory or rotary guided slide (2; 12; 22; 32).

The invention refers to a device for fastening an object on a flat carrier, particularly for furniture.

Laminate panels, i.e. panels consisting of thin surface layers having a paper core shaped in the form of a honeycomb (not considered to be the main material), are nowadays gaining ground in furniture industry. A flat carrier becomes the surface layer of a laminate panel. The object to be fastened to a flat carrier is, a furniture fitting component (hinge, shelf bracket, connecting element for panels, and the like). Fastening concerns the fastening of an object to the surface layer of a panel, without the fastening being visible on the reverse side of a panel or with the latter being damaged in any way due to fastening.

The essential problem is a question how to bring and position a nut to a flat carrier from the side facing a fitter to the side turned away from the fitter, in case of a laminate panel to the internal side of the surface layer. Into said nut a screw used to fasten said component of furniture fitting is fastened to said flat carrier, in case of furniture a laminate panel, from the fitter facing side without the nut being visible after it had been positioned to receive a screw.

The SI-A patent . . . (pat. application No. P-2003 0 0306 of Dec. 10, 2003) (Pe\ddot{c}ar et al.) describes a system of fastening to a furniture panel or the like, based on the preparation of a slot-like bearing between the surface layers and occupation of said bearing with an adequate insert that is cleft centrally between the surface layers, in a way that each half serves as a nut engaged with a screw that is screwed into it from the exterior. A disadvantage of said solution is its not being invariant to the clearance between the surface layers and for each thickness of the panel an adequate insert is to be prepared.

DE 20 2004 003 060 U1 (Häfele GmbH & Co. KG, Germany) describes a ridge plug with a bolt, whose function lies in the following: when a screw is screwed into the distal end of the ridge plug, said ridge plug shrinks and transforms in a way that each of the halves of the ridge plug forms a fold abutting against the internal side of the laminate panel surface layer. A disadvantage of said solution is that it is only applicable with laminate panels with a relatively large clearance between the surface layers, and moreover the use of two ridge plugs on the axis one opposite the other, i.e. from both sides of a panel (which is quite often in furniture industry) is practically impossible.

Based on the above basic problem and deriving from the above cited solutions, the goal of the present invention is to create a device for fastening an object on a flat carrier, particularly for furniture, that will be invariant to the size of the clearance between the surface layers of a laminate panel and that would allow for twin fastenings one below the other, each on its side of a panel.

The present invention (including fastening for each of possible furniture fitting components) concerns a variant of a device with two nuts and a variant with only one nut, whereas with both variants the translation principle of the movement of a nut(s) or rather the rotation principle of the movement of a nut(s) (a total of four solutions) is included, whereas the nut(s) are hold, secured and guided in the nut carrier of the invention.

In a device with translatory movable nuts, the nuts are slides that are identical and oriented one against the other. Said device contributes to an optimal solution as to the implementation, yet does not circumvent the inventory idea with two mutually different slides. The main components of the nut carrier are a body and a flange of the carrier. The body of the nut carrier in a built-in state is countersunk in the cutout adapted to it in the surface layer of a laminate furniture panel, when the flange of the carrier abuts the panel surface facing the fitter. The external outline of the body of the nut carrier is adequately round, so that the body of the carrier is cylindrical. The body of the nut carrier is diametrally cut out, so that the depth of said cutout comprises the thickness of the surface layer of the panel and the height distance, needed to receive slides one against the other. The essential elements of the slide are the body of the slide, a limiter, delimiting the length of its translatory movement, and a nut hole.

The device of the invention with a pair of rotary movable nuts comprises, by analogy, a nut carrier and a rotary twin slide centrally supported on it. Also in this case the main components of the nut carrier are the body and the flange of the nut carrier. The flange has cutouts engaging with holes for two screws in assembled state, said screws being used to fasten a furniture fitting component to a panel. The body of the nut carrier in a built-in state is countersunk in the oval cutout adapted to it in the surface layer of a laminate furniture panel, when the flange of the nut carrier abuts the panel surface facing the fitter. The external outline of the body of the nut carrier consists of two elements, which are basically cylinders, between which there is a hinge linking a slide to the nut carrier. The axial distance of said elements comprises at least the thickness of the surface layer of the panel. A pillar-like element is formed to the front surface of said element. The essential elements of the slide are the body of the slide and nut holes in it.

In a device consisting of an assembly of a nut carrier and only one translatory movable nut, the main components of the nut carrier are, by analogy, again a body and a flange of the nut carrier. The body of the nut carrier in a built-in state is countersunk preferably with tight fit in the cutout adapted to it in the surface layer of a laminate furniture panel, when the flange of the nut carrier abuts the panel surface facing the fitter. The external outline of the body of the nut carrier is adequately round, so that the body of the carrier is cylindrical. The body of the nut carrier is diametrally deeply cut out with a radial exit of the cutout at one end only. The depth of said cutout comprises the thickness of the surface layer of the panel and the height distance, needed to receive a slide. In the axis of said cutout a plug is formed to the flange at the side turned away from the fitter. The essential elements of the slide are the body of the slide, a limiter, and a nut hole.

The device with a rotary movable (only one) nut comprises a nut carrier and a one-nut rotary slide eccentrically supported on the nut carrier. The main components of the nut carrier are the body and the flange of the nut carrier. A plug is formed to the flange to the side turned away from the fitter. The main component of the rotary slide is a nut hole. The body of the nut carrier in a built-in state is countersunk in the cutout adapted to it in the surface layer of a laminate furniture panel, when the flange of the nut carrier abuts the panel surface facing the fitter. The external outline of the body of the nut carrier is a round plate to tight fit the cutout in the panel. The hinge connecting the slide with the nut carrier is positioned diametrally at the opposite side of the position plug. The axial extension of the body of the nut carrier comprises at least the thickness of the surface layer of the panel. A pillar-like element is formed to the front face of the body of the nut carrier.

Should the above devices of the invention be used for the fastening of elements of furniture fittings to laminate panels consisting of thin surface layers and having a paper core shaped in the form of a honeycomb, it is possible to create twin fastenings with each of the mentioned four variants or with a combination thereof one under the other each on its side of the panel.

The invention will now be described on the basis of four embodiments of the device (for the fastening of the base panel of a furniture hinge or connecting element for the connection of panels by tightening the connection via an eccentric) and their building into a laminate panel. In the enclosed sheet showing said embodiments and its integration the drawings show:

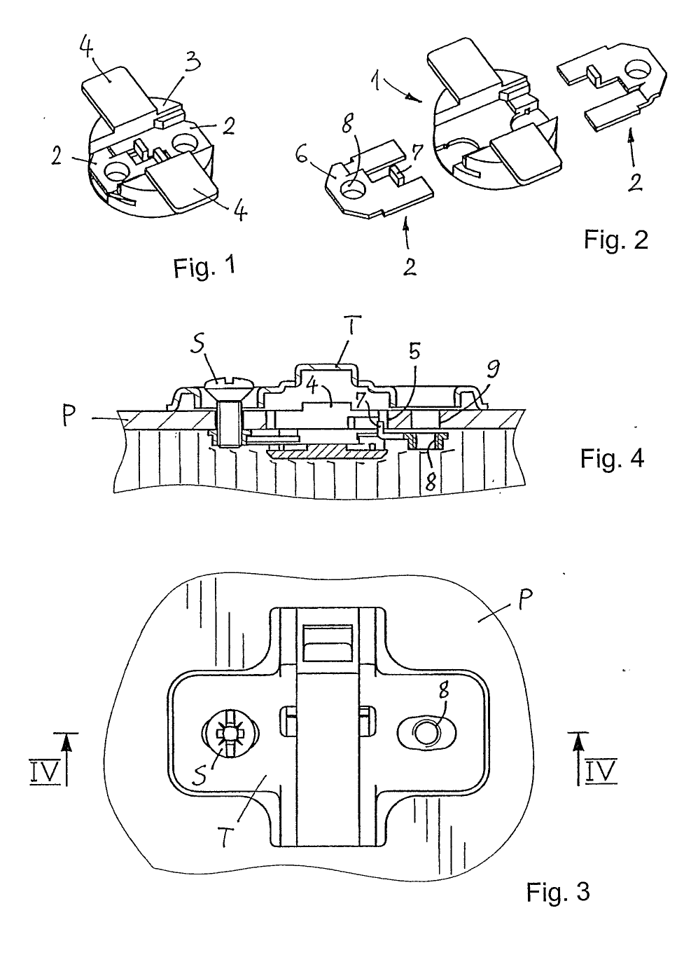

FIG. 1 a device of the invention of a translatory, two-wing type, before being positioned in a bearing in a laminate panel, in spatial presentation,

FIG. 2 a device from FIG. 1 in disassembled presentation,

FIG. 3 the base plate of a furniture hinge fastened on a furniture panel, in top view projection,

FIG. 4 a section along the line IV-IV from FIG. 3,

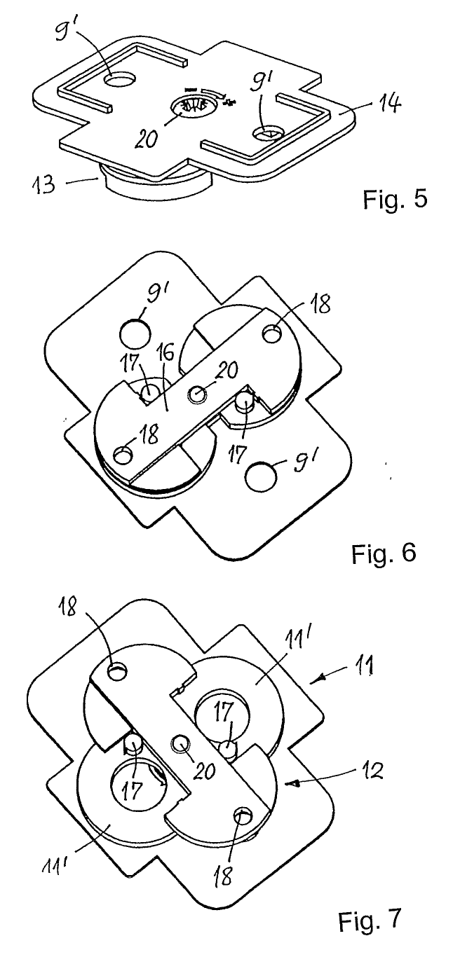

FIG. 5 as FIG. 1, only that a device of a rotary type is concerned,

FIG. 6 a device from FIG. 5 in the view from the bottom side (in the built-in state the internal side) when inserted into a bearing in a laminate panel,

FIG. 7 the same as FIG. 6, yet in the state after being locked,

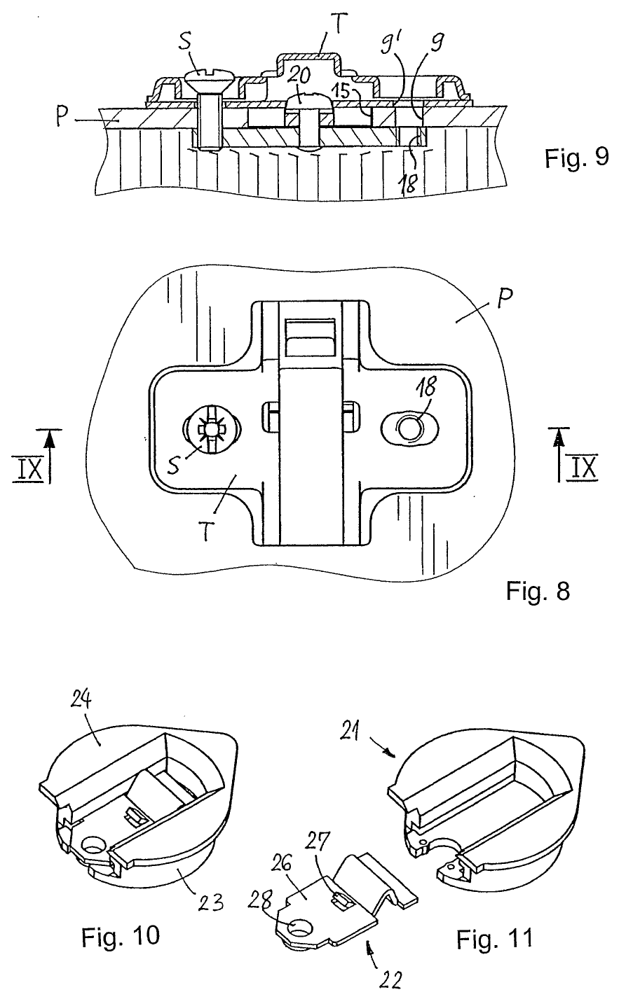

FIG. 8 the same as FIG. 3, yet used with a device from FIGS. 5 to 7,

FIG. 9 a section along the line IX-IX from FIG. 8,

FIG. 10 the same as FIG. 1, only that a one-wing type of the device is in question,

FIG. 11 disassembled presentation from FIG. 10,

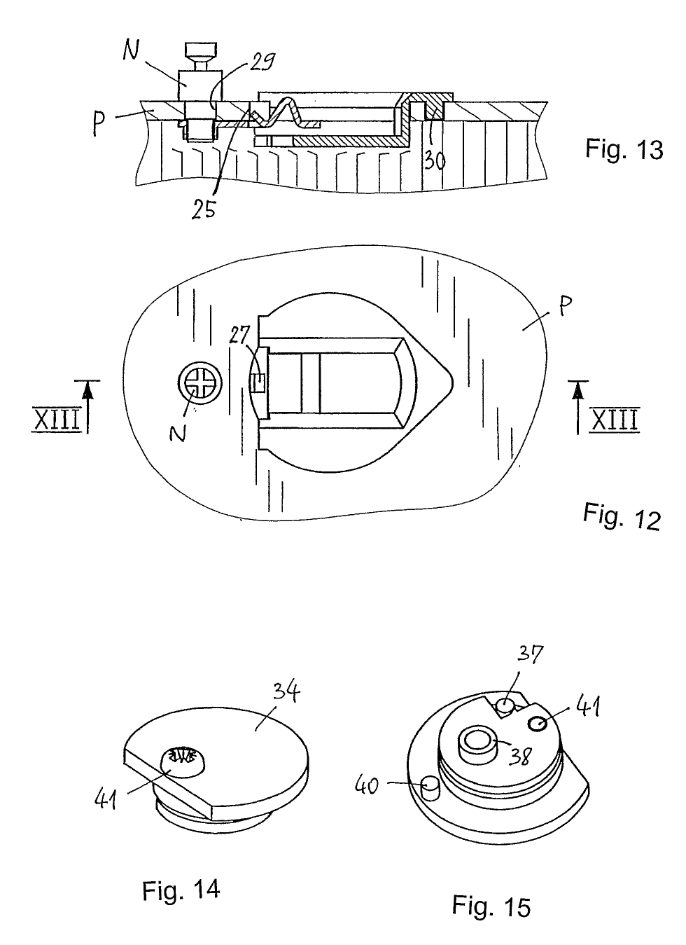

FIG. 12 connecting element built into the surface layer of a laminate panel with the device from FIG. 10-11, in top view projection,

FIG. 13 a section XIII-XIII from FIG. 12,

FIG. 14 the same as FIG. 5, only that a one-wing type of the device is concerned,

FIG. 15 a device from FIG. 14 viewed from the bottom side (in the built-in state from the internal side) in the state when positioned into a bearing in a laminate panel,

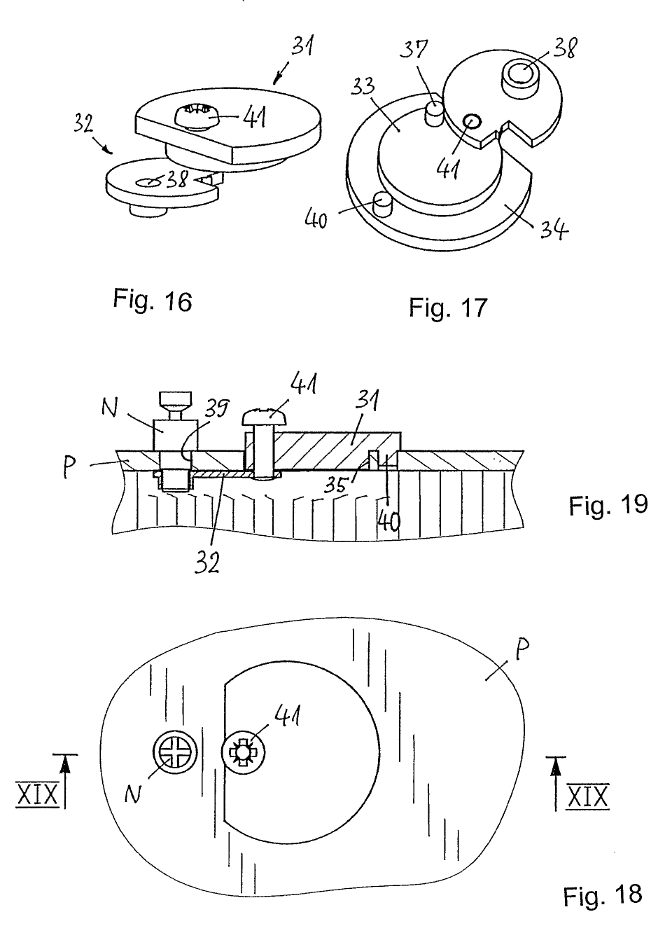

FIG. 16 the same as FIG. 14, yet in the state after being locked,

FIG. 17 the device from FIG. 16 viewed from the bottom side (in the built-in state from the internal side,

FIG. 18 the same as FIG. 12, only that the device from FIGS. 14-17 are used, and

FIG. 19 a section XIX-XIX from FIG. 18.

A device for fastening an object on a flat carrier, particularly for furniture substantially concerns an assembly of a nut carrier and nut(s), whereby the nut(s) are either translatory (FIGS. 1-4/10-13) or rotary (FIGS. 5-9/14-19) movable.

The device from FIG. 1-2 comprises a nut carrier 1 and two slides 2 that are in this embodiment, preferably always, the same and oriented one opposite the other. The main components of the nut carrier 1 are a body 3 and a flange 4 of the carrier. The body 3 of the nut carrier in a built-in state is countersunk in a cutout 5 adapted to it in the surface layer P of a laminate furniture panel (FIG. 4), when the flange 4 of the carrier—in this embodiment only limited to two diametrally positioned tongues—abuts the panel surface facing the fitter. The external outline of the body 3 of the nut carrier is substantially round, so that the body 3 is basically cylindrical. The body 3 of the nut carrier is diametrally deeply cut out crosswise to the tongues of the flange 4, so that the depth of said cutout comprises the thickness of the flat carrier, in this case the thickness of the surface layer P of the panel and the height distance, needed to receive slides 2. The slides 2 in a built-in state are in loose distance from the surface layer P of the panel turned away from the fitter. The essential elements of the slide 2 are a body 6 of the slide, a limiter 7 and a nut hole 8. The limiter 7 is an element delimiting the length of the translatory shift of the slide 2 radially out from the body 3 of the nut carrier under the surface layer P of the panel and is abutted to the wall of the cutout 5 when assembled (FIG. 4, right side). It is understood that the nominal distance from the limiter 7 to the axis of the nut hole 8 is selected in a way that in the assembled position of the slide 2 the axis of the nut hole 8 substantially overlaps with the axis of the hole 9 for the screw S, used to fasten the component of a furniture hinge, in this case the base plate T of a furniture hinge (FIGS. 3-4) to the panel. The state of the device before being built in is shown on FIG. 1. The slides 2 are stored within the external outline of the body 3 of the nut carrier. To hold and also to securely hold and guide the slide 2 in the body 3, optional holding and locking elements or guides are used. If only one-way positioning of slides 2 with respect to the holes 9 should be established, engaging means should be provided at the cutout 5 or the nut carrier 1 e.g. of the type groove/tongue (not shown on figures).

The device from FIGS. 5-7 comprises a nut carrier 11 and a centrally supported rotary twin slide 12 thereon. The main components of the nut carrier 111 are a body 13 and a flange 14 of the carrier. The flange 14 in this embodiment has cutouts 9′, overlapping in assembled state with the holes 9 for the screws S, with which the component of furniture fitting, in this case the base plate T of furniture hinge (FIG. 8-9) is fastened to the panel. The body 13 of the nut carrier in a built-in state is countersunk in an oval cutout 15 (FIG. 9) adapted to it in the surface layer P of a laminate furniture panel, when the flange 14 of the carrier—in this embodiment limited to four crosswise positioned tongues—abuts the panel surface facing the fitter. The external outline of the body 13 of the nut carrier consists in this case of two elements 11′, which are substantially cylinders, between which a hinge 20 is positioned, said hinge linking the slide 12 to the nut carrier 11. The axial distance of said elements 111′ comprises at least the thickness of the flat carrier, in this case the thickness of the surface layer P of the panel. The slide 12 axially abutting the elements 11′ in a built-in state is in a loose distance from the surface layer P of the panel turned away from the fitter. A pillar-like element 17 is formed to the front face of the element 11′, said element functioning as the limiter of the turning of the slide 12. The essential elements of the slide 12 are a body 16 of the slide and nut holes 18 thereon. The element 17 is an element delimiting the turning movement of the slide 12 as to the oval cutout 15 under the surface layer P of the panel, measured to 90°. It is understood that the position of the limiter 17 is selected in a way that in the preparatory state (FIG. 6) the slide 12 overlaps with the cutout 15 and in the assembled position (FIG. 7) the axis of the nut hole 18 at least substantially overlaps with the axis of the holes 9, 9′ for the screw S, used to fasten the component of a furniture hinge, in this case the base plate T of a furniture hinge to the panel. Since the nut carrier 11 in built-in state engages with the oval cutout 15, no additional positioning means to define engagement are needed.

The embodiment FIG. 10-13 is a one-nut variant from the embodiment FIG. 1-4, here for the needs of fastening (of the panel into the hole 29) of a connecting element N (FIG. 13) for the connection of panels by tightening the link via (not shown) an eccentric. The device comprises a nut carrier 21 and a slide 22. The main components of the nut carrier 21 are a body 23 and a flange 24 of the carrier. The body 23 of the nut carrier in a built-in state (FIG. 13) is countersunk preferably in tight fit in a cutout 25 adapted to it in the surface layer P of a laminate furniture panel, when the flange 24 of the carrier abuts the panel surface facing the fitter. The external outline of the body 23 of the nut carrier is substantially round, so that the body 23 is basically cylindrical. The body 23 of the nut carrier is diametrally deeply cut out with a radial exit of the cutout at one end only. The depth of said cutout comprises the thickness of the flat carrier, in this case the thickness of the surface layer P of the panel and the height distance, needed to receive the slide 22. In the axis of said cutout a plug 30 is formed to the flange 24 at the side turned away from the fitter, said plug securing directional definition of the device in the built-in state of the device with engagement with an adapted cutout in the surface layer P of the panel. The slide 22 in a built-in state is in loose distance from the surface layer P of the panel turned away from the fitter. The essential elements of the slide 22 are a body 26 of the slide, a limiter 27 and a nut hole 28. The limiter 27 is an element delimiting the length of the translatory movement of the slide 22 radially from the body 23 of the nut carrier under the surface layer P of the panel and is abutted to the wall of the cutout 25 (FIG. 13) when assembled. It is understood that the nominal distance from the limiter 27 to the axis of the nut hole 28 is selected in a way that in the assembled position of the slide 22 the axis of the nut hole 28 at least substantially overlaps with the axis of the element N fastened to the panel. The state of the device prior to building-in is shown on FIG. 10. The slide 22 is positioned within the external outline of the body 23 of the nut carrier. To hold and also to securely hold and guide the slide 22 in the body 23, optional holding and locking means or guides are used.

The embodiment FIG. 14-19 is a one-nut variant from the embodiment FIG. 5-9, here for the needs of fastening a connecting element N (FIG. 19) into the panel for the connection of panels by tightening the link via an (not shown) eccentric. The device comprises a nut carrier 31 and a one-nut rotary slide 32 eccentrically supported. The main components of the nut carrier 31 are a body 33 and a flange 34 of the carrier. A plug 40 is formed to the flange 34 at the side turned away from the fitter, said plug securing directional definition of the device in built-in state of the device with engagement with an adapted cutout in the surface layer P of the panel. The main element of the rotary slide 32 is a nut hole 38, which, in the assembled state, overlaps with the hole 39 for the element N. The body 33 of the nut carrier in a built-in state is countersunk in a cutout 35 (FIG. 19) adapted to it in the surface layer P of a laminate furniture panel, when the flange 34 of the carrier, in this case a truncated round plate, abuts the panel surface facing the fitter. The external outline of the body 33 of the nut carrier is a round plate in this case to tight fit the cutout 35. A hinge 41 connecting the slide 32 with the nut carrier 31 is positioned at the truncated side of the flange 34 diametrally opposite the plug 40. The axial distance of the body 33 comprises at least the thickness of the flat carrier, in this case the thickness of the surface layer P of the panel. The slide 32 axially abutting against the body 33, in a built-in state is in loose distance from the surface layer P of the panel turned away from the fitter. A pillar-like element 37 (FIG. 17) is formed to the front face of the body 33, said element functioning as the limiter of the turning of the slide 32. The element 37 is an element delimiting the turning movement of the slide 32 as to the hole 39 in the surface layer P of the panel. It is understood that the position of the limiter 37 is selected in a way that in the preparatory state (FIG. 14-15) the slide 32 overlaps with the body 33 and the cutout 35 and in the assembled position (FIGS. 16, 17) the axis of the nut hole 38 at least substantially overlaps with the axis of the hole 39. To hold the preparatory state engaging locking elements are provided with the limiter 37 at the slide 32.

1: Device for fastening an object on a flat carrier, especially for furniture, characterized in that it is a set of a nut carrier (1; 11) and two nuts guided in it.

2: Device according to claim 1, characterized in that it concerns a concept of translatory movable nuts.

3: Device according to claim 1, characterized in that the nuts are slides (2) that are identical and oriented one against the other.

4: Device according to claim 1, characterized in that the main components of the nut carrier (1) are a body (3) and a flange (4) of the carrier.

5: Device according to claim 4, characterized in that the body (3) of the nut carrier in a built-in state is countersunk in the cutout (5) adapted to it in the surface layer (P) of a laminate furniture panel, when the flange (4) of the carrier abuts the panel surface facing the fitter.

6: Device according to claim 5, characterized in that the external outline of the body (3) of the nut carrier is adequately round and the body (3) is cylindrical.

7: Device according to claim 6, characterized in that the body (3) of the nut carrier is diametrally cut out, so that the depth of said cutout comprises the thickness of the surface layer (P) of the panel and the height distance, needed to receive slides (2).

8: Device according to claim 3, characterized in that the essential elements of the slide (2) are the body (6) of the slide, a limiter (7) and a nut hole (8).

9: Device according to claim 1, characterized in that it concerns a concept of rotary movable nuts.

10: Device according to claim 9, characterized in that it comprises a nut carrier (11) and a rotary twin slide (12) centrally supported on it.

11: Device according to claim 10, characterized in that the main components of the nut carrier (11) are the body (13) and the flange (14) of the nut carrier.

12: Device according to claim 11, characterized in that the flange (14) has cutouts (9′) engaging with holes (9) for two screws (S) in assembled state, said screws being used to fasten a furniture fitting component to a panel.

13: Device according to claim 12, characterized in that the body (13) of the nut carrier in a built-in state is countersunk in the oval cutout (15) adapted to it in the surface layer (P) of a laminate furniture panel, when the flange (14) of the nut carrier abuts the panel surface facing the fitter.

14: Device according to claim 13, characterized in that the external outline of the body (13) of the nut carrier consists of two elements (11′), which are basically cylinders, between which there is a hinge (20) linking a slide (12) to the nut carrier (11).

15: Device according to claim 14, characterized in that the axial distance of said elements (11′) comprises at least the thickness of the surface layer (P) of the panel.

16: Device according to claim 13, characterized in that a pillar-like element (17) is formed to the front face of said element (11′).

17: Device according to claim 10, characterized in that the essential elements of the slide (12) are the body (16) of the slide and nut holes (18) in it.

18: Device for fastening an object on a flat carrier, especially for furniture, characterized in that it is a set of a nut carrier (21; 31) and only one nut.

19: Device according to claim 18, characterized in that it concerns a concept of translatory movable nuts.

20: Device according to claim 18, characterized in that it comprises a nut carrier (21) and a slide (22).

21: Device according to claim 20, characterized in that the main components of the nut carrier (21) are the body (23) and the flange (24) of the nut carrier.

22: Device according to claim 21, characterized in that the body (23) of the nut carrier in a built-in state is countersunk preferably with tight fit in the cutout (25) adapted to it in the surface layer (P) of a laminate furniture panel, when the flange (24) of the nut carrier abuts the panel surface facing the fitter.

23: Device according to claim 22, characterized in that the external outline of the body (23) of the nut carrier is adequately round, so that the body (23) is basically cylindrical.

24: Device according to claim 22, characterized in that the body (23) of the nut carrier is diametrally deeply cut out with a radial exit of the cutout at one end only.

25: Device according to claim 24, characterized in that the depth of said cutout comprises the thickness of the surface layer (P) of the panel and the height distance, needed to receive a slide (22).

26: Device according to claim 25, characterized in that in the axis of said cutout a plug (30) is formed to the flange (24) at the side turned away from the fitter.

27: Device according to claim 20, characterized in that the essential elements of the slide (22) are the body (26) of the slide, a limiter (27) and a nut hole (28).

28: Device according to claim 18, characterized in that it concerns a concept of rotary movable nuts.

29: Device according to claim 28, characterized in that it comprises a nut carrier (31) and a one-nut rotary slide (32) eccentrically supported on it.

30: Device according to claim 29, characterized in that the main components of the nut carrier (31) are the body (33) and the flange (24) of the nut carrier.

31: Device according to claim 30, characterized in that a plug (40) is formed to the flange (34) to the side turned away from the fitter.

32: Device according to claim 31, characterized in that the main component of the rotary slide (32) is a nut hole (38).

33: Device according to claim 30, characterized in that the body (33) of the nut carrier in a built-in state is countersunk in the cutout (35) adapted to it in the surface layer (P) of a laminate furniture panel, when the flange (34) of the nut carrier abuts the panel surface facing the fitter.

34: Device according to claim 33, characterized in that the external outline of the body (33) of the nut carrier is a round plate to tight fit the cutout (35).

35: Device according to claim 29, characterized in that the hinge (41) connecting the slide (32) with the nut carrier (31) is positioned diametrally opposite the plug (40).

36: Device according to claim 30, characterized in that the axial extension of the body (33) comprises at least the thickness of the surface layer (P) of the panel.

37: Device according to claim 36, characterized in that a pillar-like element (37) is formed to the front face of the body (33).
